(19) United States
(12) Patent Application Publication
(10) Pub. No.: US 2015/0165456 A1
(43) Pub. Date: Jun. 18, 2015

(54) PAINT SPRAY-GUN HOUSING STRUCTURE

(71) Applicant: Hsien-Chao SHIH, Changhua City (TW)

(72) Inventor: Hsien-Chao SHIH, Changhua City (TW)

(21) Appl. No.: 14/109,325

(22) Filed: Dec. 17, 2013

(51) Int. Cl. B05B 7/12

(52) U.S. Cl. CPC B05B 7/12

(57) ABSTRACT

The present invention is to provide a paint spray-gun housing structure, in particular an innovative design to improve atomization result in spraying paint, mainly a protruding installation at internal edge of the flank section on both sides of spray-gun housing for expanding diameter in the outer section of atomization airflow channel, in particular to expand diameter horizontally oval hole in order to add at least two atomizing holes at the wider and thicker position near the base of the flank section, and enable the atomizing holes aligned in horizontal direction, thereby the atomization airflow passing through the two flank sections of the spray-gun housing is directed to spit out from the atomizing hole, in particular for the paint spitted from the center of the spray-gun housing to form still wider and more even results, so that while expanding and adding the spraying area the spraying quality can be maintained.

### FIELD OF THE INVENTION

The present invention is about a paint spray-gun housing structure, mainly is a planned design to allow atomization airflow channel produced inside the two flank sections of the spray-gun housing so that the horizontally aligned atomizing hole additionally installed at the base of the air outlet near the center of the flank section so the atomization airflow to enable the paint spitted from the center of the spray-gun housing to form more wider and even blowing and squeezing effect, thereby while expanding and adding the spraying area its spraying quality is maintained.

### DESCRIPTION OF THE PRIOR ART

Normally in the structural design of paint spray-gun mainly is to install a spray-gun main body suitable for holding in hand. At the lower side of the handle of the spray-gun main body a connector is installed for connecting to the air compression device, and a knob is installed to control the inlet air volume matched with the pressing handle installed in the cavity section of upper section of the handle so as to control the trigger intersecting the cavity section of the spray-gun main body to control the opening of the nozzle at the front end. And the control knob at the back end of the cavity section is used to adjust the strength of the controlling pressure and the magnitude of the opening. Again, at the back end of the spray-gun main body another adjustable knob is installed separately to adjust the outlet air volume of nozzle at the front end, for adjusting the degree of atomization. With this constituent, the basic functional structure of this type of paint spray-gun to match the introduction of inlet air provided by the air compression device to spit out through the internal air passage by releasing the nozzle controlling the trigger through the pressure of the handle. And while letting out the air the paint in the paint can is spit out altogether by matching with the lateral spit air installed at the flank section on both sides of the spray-gun housing so as the paint is spread evenly in atomization on the object under work. At the same time depending on the requirement of work object and operating environment the lateral gas spitting volume is obtained through knob adjustment of spray-gun housing to adjust the atomization result of paint spray and further to obtain the best paint spraying quality.

In order to form suction effect and spit paint together while the spraying air flow is spit out from nozzle, the paint outlet of the nozzle is slotted on the air outlet of the center of spray-gun housing so that the spitting paint air flow is blown off from the gap between air outlet and paint exit nozzle and at the same time leads paint to spit out. Hence, the paint presents in circular form assisted by the squeezing effect of atomization air flow blown from lateral direction from the protruding flank section on both sides of the spray-gun housing, so that the paint is squeezed to present flat spraying shape, and through the adjustment of air outlet volume of atomization air flow to vary the spraying range. Under this operating mode, the spraying area is adjusted through the amount of atomization air flow, leading to the uneven painting overall painting due to the excessively thin or locally thick phenomena possibly due to the inexperience of operating personnel or improper adjustment, indeed deserve the effort to improve and resolve the problem.

### DESCRIPTION OF THE INVENTION

In view of the problem and flaw easily existing in the spraying operation of paint spray-gun, the inventor engaged in the research of improvement. Due to many years of experience in related industry and technique, the paint spray-gun housing structure is further invented with the purpose of improving the design of structure to increase the spraying range of the atomization air flow when the paint is just sprayed out in order to effectively squeeze the paint to form more even long and flat spraying style.

The other objective of the present invention is in the composite design through structure by additional installation of lateral spitting hole at the base of protruding flanks on both sides in order to increase its spraying range, enabling the paint more easily and evenly blown and squeezed into long and flat form.

To achieve the objective revealed previously, the structural design of the present invention is mainly to install expand the diameter of the outer section of the atomization airflow channel on the inner edge of the flank section on both sides of the spray-gun housing, in particular the adopted lateral oval hole expanded diameter, so as to increase the installation of at least two atomizing holes on the wider and thicker position near the base of the flank section, and render the atomizing holes to align horizontally. In doing so, as the atomization airflow produced internally in the flank section of both sides of the spray-gun housing spitted out atomizing holes, the spitted paint from the center of spray-gun housing forms wider and even blown and squeezed result so that while expanding and increasing the spraying area the its spraying quality is also taken care of.

### BRIEF DESCRIPTION OF DRAWINGS

FIG. 1 is the drawing of the structure of the preferred embodiment of the present invention.

FIG. 2 is the drawing of local structure of the preferred embodiment of the present invention.

FIG. 3 is the drawing of the structural relationship of the embodiment of the present invention.

FIG. 4 is the drawing of the structural relationship in another viewing angle of the embodiment of the present invention.

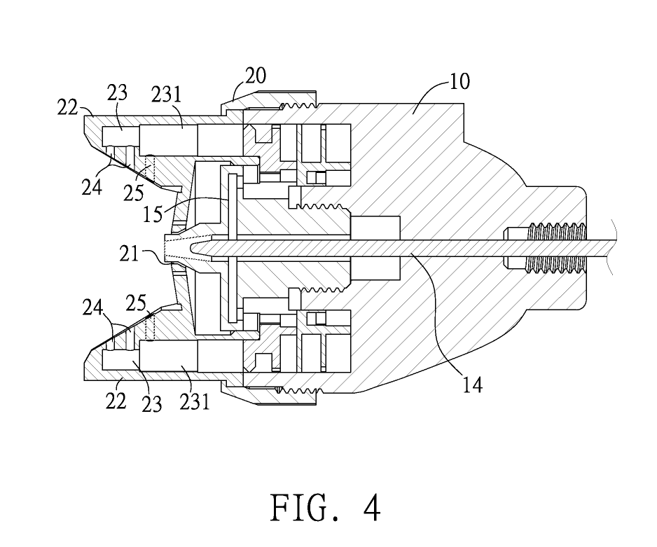

FIG. 5 is the drawing of the planar structural relationship of the preferred embodiment of the present invention.

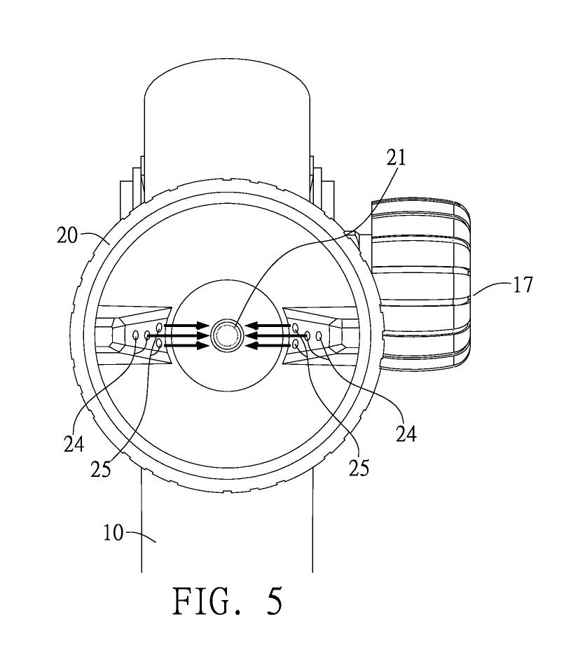

FIG. 6 is the drawing of the paint spraying operation of the embodiment of the present invention.

### DETAILED DESCRIPTION OF THE ELEMENTS

(10) Spray-gun main body
(11) Connector
(12) Air inlet knob
(13) Pressing handle
(14) Trigger
(15) Nozzle
(151) Paint outlet nozzle
(16) Control knob
(17) Adjustment knob
(20) Spray-gun housing
(21) Air outlet
(22) Flank section
(23) Atomization airflow channel
(231) Expanded diameter hole section
(24) (25) Spitting hole

### DESCRIPTION OF THE PREFERRED EMBODIMENT

Regarding to the structural constituent, technical means, and results achieved for the present invention, the embodiment of the present invention is further elaborated with drawings as below:

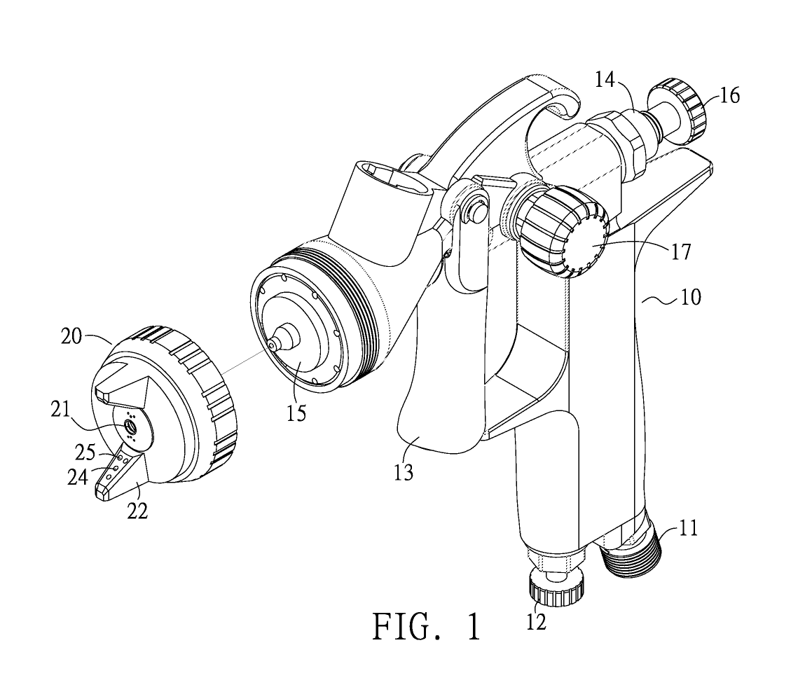

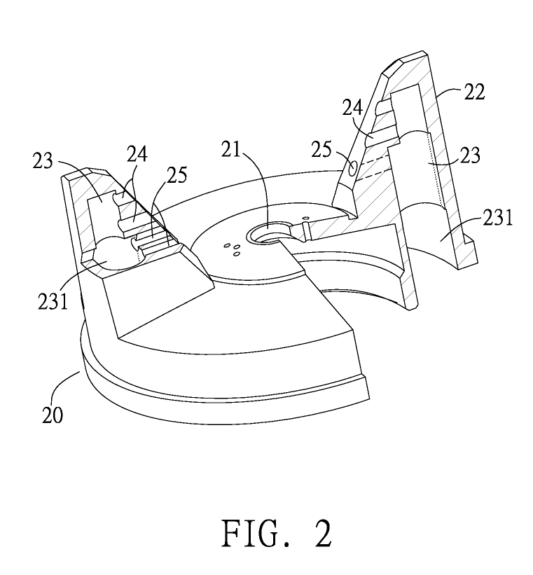

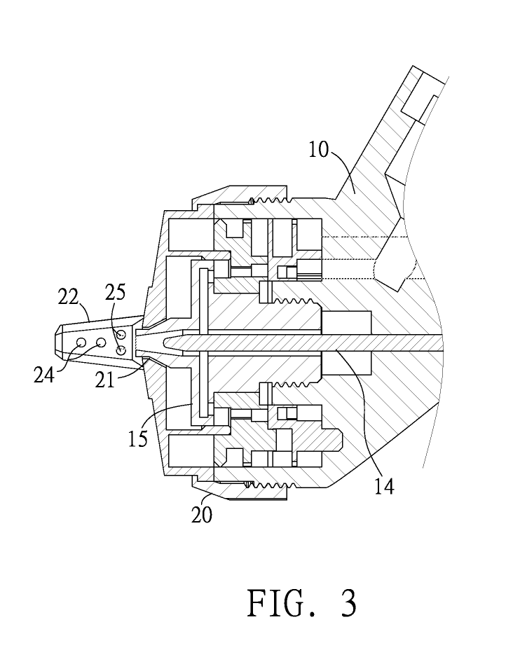

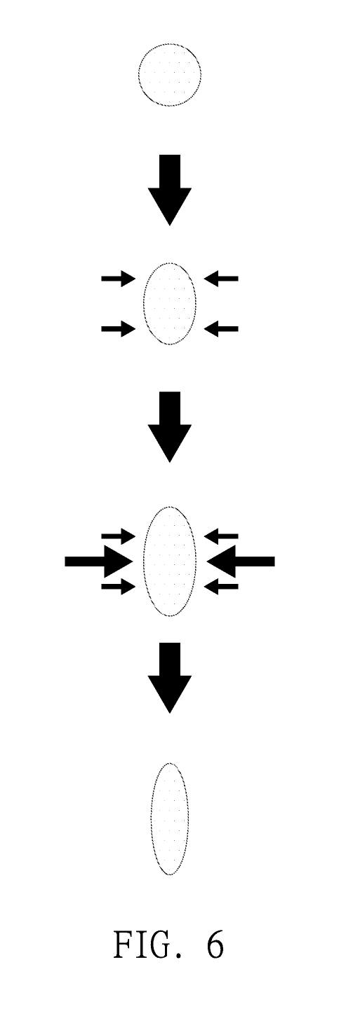

Please refer to FIG. 1 the structural illustration, FIG. 2 the illustration of local structure, FIGS. 3˜5 the illustrations of structural relationship, and FIG. 6 the illustration of the operation for the description of the embodiment of the present invention. As shown in the illustrations, the structural design of the present invention basically follows the current functional structure of existing spray-guns, mainly installed with a spray-gun main body (10) suitable for holding in hand; the handle of the spray-gun main body is installed with a connector (11) for connecting to a air compression device; and the lateral side is installed with an air inlet knob (12) for adjusting inlet air volume. To accommodate the pressing handle (13) installed on the upper end of the cavity of the handle for control of spray-gun main body (10), the cavity is cross installed with trigger (14) for the control of opening at front end nozzle (15), and with the control knob (16) at the back of the cavity of the spray-gun main body (10) opening to control the pressure force and amplitude of the opening. Again, in the back of the cavity of the spray-gun main body (10) or the other side, another adjustment knob (17) is installed to control the spray-gun main body (10) by utilizing the diverting volume formed by the paint spraying airflow and atomization airflow between main channel and by-channel in order to adjust the air blown from the air outlet (21) of center of spray-gun housing (20) and the lateral spitting hole (24) on the protruding flank section (22) installed on both sides to achieve the control of paint volume and atomization degree, thereby constituting the basic functional structure of paint spray-gun of the present invention;

To enable the paint more even while spraying and further to increase the spraying area, the present invention aims at its atomization airflow of introducing spitting aspect undergo design with installation of atomization airflow channel (23) inside protruding flank section (22) on two sides of spray-gun housing (20) for guiding atomization airflow and from the internal side of air outlet (21) of the center of the spray-gun housing (20) installed preset number of spitting holes (24) penetrating in the internal atomization airflow channel (23). And the atomization air flow channel (23) relative to the nozzle (20) and the spray-gun main body (10) interlocked to the outer section of the channel is installed with an expanded diameter hole section (231), particularly the expanded diameter hole section (231) adopts installation intersecting to horizontal oval expanded diameter style of the flank section (22). In this way, at least two atomizing holes (25) are installed additionally in the wider and thicker position near the base of the flank section (22), and the atomizing holes (25) installed additionally are aligned in the horizontal direction, different from the original vertical alignment. Thereby the horizontal spraying range is enhance, constitutes the improvement structure of spray-gun housing (20) of the present invention;

Through the structural design revealed above, due to the at least two horizontal rows of atomizing holes (25) additionally installed near the base of the flank sections (22) on both sides of spray-gun housing (20) the paint is blown out from the air outlet (21) from the center of the spray-gun housing (20) with paint spraying airflow and guided to spit out from nozzle (15), the atomization airflow is also guided to spit out from nozzle (15) with spraying paint stream blown out from outlet (21) of the center of spray-gun housing (20) with spraying paint airflow, the atomization airflow is also synchronously guided to spit out from atomizing holes (24) (25) through atomization airflow channel (23) internally produced from the flank section on the both sides of the spray-gun housing (20), rendering the paint to form squeezing result, particularly through the additionally installed horizontally aligned atomizing holes (25) near the base of the flank sections (22) on both sides, enabling the paint attracted by the spraying airflow and spit out from the center position of the spray-gun housing (20), therefore formed by atomizing airflow to form wider and more even squeezing so that the paint is easily blown into long and flat spraying pattern (above please refer to FIG. 6) and no uneven paint phenomena is presented. Hence while expanding and increasing the spraying area, its painting quality is improved synchronously;

In other words, from the above description we know that while the present invention without changing existing functional structure, through the plan of enabling atomization airflow at the flank section on the both sides of spray-gun housing to flow through oval pattern expanded diameter hole section at outer section, the horizontally aligned atomizing holes are additionally installed so that when the paint is spit out with paint airflow, the atomization airflow forms wider and more even squeezing action through the blown atomization airflow; in this way, the paint is expanded and dissipated evenly and presenting long and flat painting pattern, achieving the objective of expanded painting area, and as the paint evenness is maintained it is clearly beneficial to the improvement of paint quality, further endows the spray-gun with high efficiency, high quality practical value.

In summary, the paint spray-gun housing structure of the present invention with design of outset section expanded diameter hole section through internally produced atomization airflow channel at flank section on both sides of the spray-gun housing is specially additionally installed with horizontally aligned atomizing holes at the base position of the flank section, further forms wider and even squeezing result for paint that on the functional basis expands the painting area and further has the advantage of maintaining its painting evenness and ensures the quality of the overall painting operation. As a whole, it truly has extremely good industrial utility and practical value and is indeed a superior and outstanding innovative design. We hereby propose to file the patent application.

1. A paint spray-gun housing structure comprising:
a spray-gun main body suitably installed for holding in hand, having a guiding stream and diverting channels inside, connecting to an air compression device at the lower side of the handle section of spray-gun main body with a air inlet knob for control of inlet air volume on the side, and on the upper end of the cavity section of the handle is assembled with a pressing handle cross trigger installed internally;
a trigger under the pressure of pressing handle controls the opening of the nozzle in front, wherein the paint outlet nozzle is slotted on the air outlet in the center of the spray-gun housing assemble on the front of a cavity section of the spray-gun main body;
both sides of the spray-gun housing having protrusions installed with a pair of flank sections with spitting holes;
a control knob installed at the back end of the cavity of the spray-gun main body for controlling the strength of the pressing handle and opening amplitude of the nozzle;
an adjustment knob installed in the reserved location in the cavity of the spray-gun main body for adjusting the spraying paint stream output from the spray-gun main body and diverted flow of atomization airflow, wherein the spraying paint airflow is blown out from the air outlet of the center of the spray-gun housing and the atomization airflow is spit out from the spitting hole of flank sections on both sides of the spray-gun housing; and
an atomization airflow channel installed at the interior of the protruding flank section on both sides of the spray-gun housing for introducing atomization airflow, wherein installed an expanded diameter hole section for the channel outer section that is the interlocking interface relative to the nozzle and spray-gun main body and the wider and thicker position near the base of the flank section is additionally installed with at least two atomizing holes horizontally installed aligned in order to enhance horizontal spitting range whereby the paint spitted from the center of the spray-gun housing and form wider and more even squeezing.

2. The paint spray-gun housing structure description of claim 1, the expanded diameter hole section of the outer section of the internally produced atomization airflow channel of the flank section on both sides of the spray-gun housing is designed and installed in oval pattern.

3. The paint spray-gun housing structure description of claim 1, the expanded diameter hole section of the outer section of the internally produced atomization airflow channel of the flank section on both sides of the spray-gun housing is designed and installed in oval pattern horizontally crossed with the flank section.
